(19) United States
(12) Patent Application Publication
(10) Pub. No.: US 2018/0161780 A1
(43) Pub. Date: Jun. 14, 2018

(54) Manual meat shredder for empanada meats and others dishes

(71) Applicant: Emma Eugenia Mesa-Arias, Manizalez (CO)

(72) Inventor: Emma Eugenia Mesa-Arias, Manizalez (CO)

(21) Appl. No.: 15/830,129

(22) Filed: Dec. 4, 2017

(30) Foreign Application Priority Data
Dec. 5, 2016 (CO) NC2016/0005016

(51) Int. Cl. B02C 18/28; A22C 17/00

(52) U.S. Cl. CPC B02C 18/28; A22C 17/0026

(57) ABSTRACT

A machine for manual action that releases, shreds or defrays the different fibers of meat for human consumption, be it chicken, beef, pork or any other suitable animals that have fibers. These are characterized by having a bar of different shapes located on the periphery of a shaft which has a handle for manual action so that when the operator turns the handle, bars that are located linearly and equidistant on an axis rotate so that the meat pieces located in the tray enter through an opening and collide between the bars inside the casing. The rotating and fixed bars swivel between said bars and rods, allowing the bars to rotate without colliding or crossing. Through this movement, the pieces of meat are shredded or defrayed in different sizes, depending on the distance and speed between the linear bars moving and those that are fixed. Note the system may also work with either reduction gears and or a reduction motor. This shredder may be attached to the table via a vise or similar mechanism.

### DESCRIPTION OF THE INVENTION

### History of the Invention

This invention is about the Processing of Meat, specifically of the shredding of meats, such as beef, pork, etc., used for the preparation of food products that contain shredded beef, such as empanadas, burritos, pasta, pizza and other culinary dishes. The process is generally accomplished through manual means, or as shown in patent application PCT/MX2002/000108 as used in the preparation of food products that contain shredded meats in empanadas, patties, pastries, burritos, pizza and other such delicacies. The invention's sector is metal and mechanical, for the shredding of chicken, beef or pork using a either a manually operated machine, or one with a reduction motor.

### Object of the Invention

The principal object of the invention is the creation of a manual meat shredder is to allow the shredding through a manually operated lever/handle or through the use of a reduction gear motor in an easy and quick way.

Other Objective of the invention is to save time, reduce the exposure to contaminant as well as to increase meat quality.

Am important objective is that the thickness of the shredded beef may be adjusted as a function of the distance between the lines of bars located linearly and in the periphery of the axle carrying said bars.

A further objective is to allow the aseptic handling of the meat, as the operator need not touch the meat, and as the product is manufactured in stainless steel.

### Description

This invention is about a manual machine which loosens/releases (shredding or ‘desmechando’) the fibers in the various meats 14 for human consumption, be they chicken, beef or pork. This shredding beef is operated through manual action 1 and is characterized for the ability to shred/‘desmechar’ the various fibers of the meat consumed by humans, being designed to have good performance in the shredding of beef or chicken, having a main purpose of saving time, reduce exposure to contaminants and attain quality. The machine is characterized by having bars 3 with different shapes; circular/cylindrical bars, triangular bars or square bars located in the periphery of a central axis 2 so each bar line formed along the periphery of the central axis 2 may have two, three, four, five, six, seven or eight bars 3 that rotate through the action of a lever/handle actuated by the operator's arm/hand, who grabs the handle 9 which transmits the force to the rod 8, though the axle 6 of the lever connecting the central axis 2 which supports the housing/chassis 5 between the slots 7. This central axis/shaft 2 carrying the Bars 3, which are located equidistant and in a row with the area of rotation and are further interspaced with the permanently fixed (i.e. Affixed) bars 4 and further may also be of different shapes; as bars with circular (cylindrical), triangular or square cross sections and equidistant to the rotational bars 3 so that they cross the fixed bars 4, effecting tearing and/or shredding of the meat 14 in the tray 12, which are manually fed through the upper part or mouth 19, shred/tear 14 as the meat pieces 13 crash with the rotating bars 3 against the fixed bars 4 and the housing 5 in different thickness, which depends on the adjustable and parallel space/distance between the rotating bars 3 and the affixed ones 4. The central axis 2 anchors the housing 5 through screws 18.

### BRIEF DESCRIPTION OF THE FIGURES

FIG. 1 shows a perspective top view of the manual machine and crank.

FIG. 2 shows a perspective top view of the manual machine and crank.

FIG. 3 shows a Top view of the manual machine and crank.

FIG. 4 shows a perspective side view of the manual machine with a tray and meat.

FIG. 5 shows a front view of the manual machine and crank.

FIG. 6 shows a side view of the manual machine having a meat input housing mounted.

FIG. 7 shows a side view of the machine powered by a reduction motor.

### DETAILED DESCRIPTION OF THE FIGURES

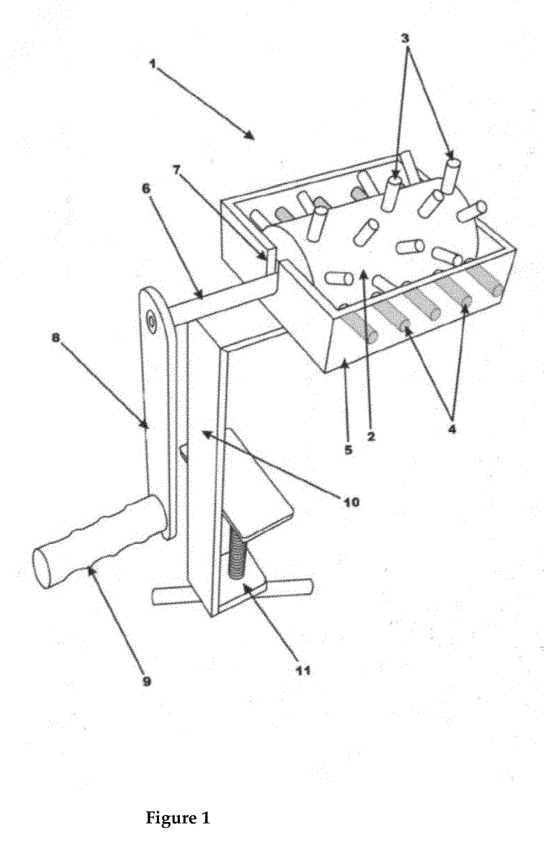

FIG. 1 shows the manual meat shredder 1, having a rotating bar 3 carrier 2 having circular shaped rotating bars 3 and fixed location bars 4 also having a circular cross section, mounted on a rotating surface 2, which is supported over the housing/chassis 5 slots 7 and actuated by the handle 9 connected to the arm/lever/crank 8 through shaft 6.

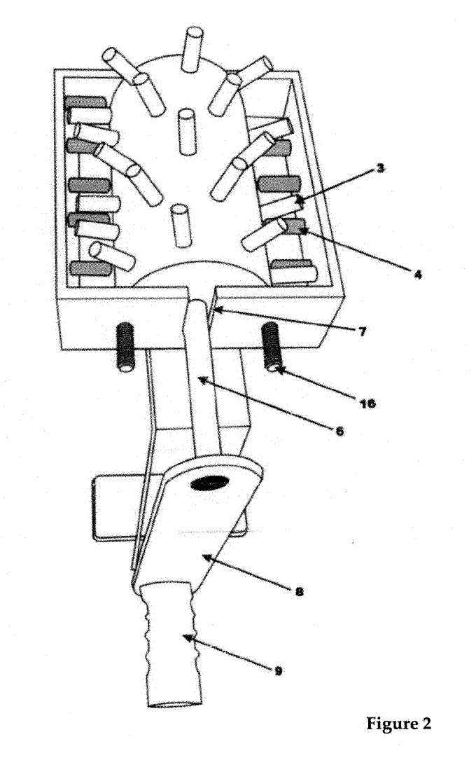

FIG. 2 shows the manual meat shredder 1 shaft 6 connecting the rotating bar 3 carrier 2, having circular shaped rotating bars 3 showing them rotating without making contact with affixed bars 4, said affixed bars being attached to the chassis/housing 5, the housing slot 7 supporting the shaft 6 in turn supporting the rotating bar carrier 2 whose rotation is caused by the rotation of the handle 9 connected to the rod/lever 8. In addition, it shows the studs 16 which connect it to the hopper 14

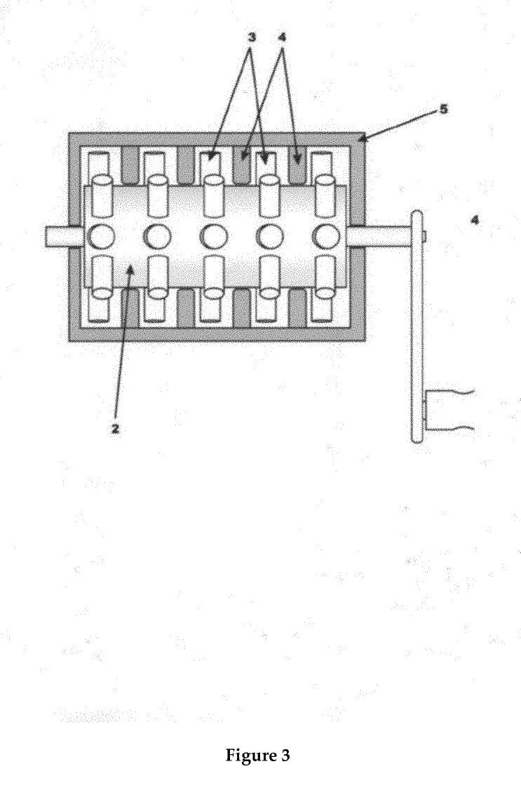

FIG. 3 shows the manual meat shredder 1 overlap between the rotating bars 3 mounted on the rotating bar carrier 2 and the housing 5 mounted fixed bars 4 which allows for the contactless rotation between bars, and for the gap between said bars to shred the meat chunks 13.

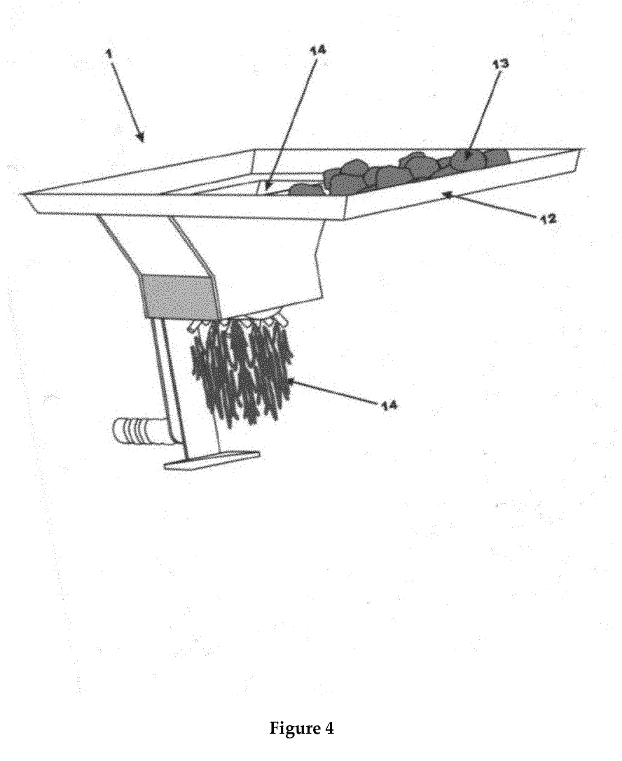

FIG. 4 shows the manual meat shredder 1, tray 12 with pieces of meat 13 to be fed into the mouth/entry 19 of the hopper 14.

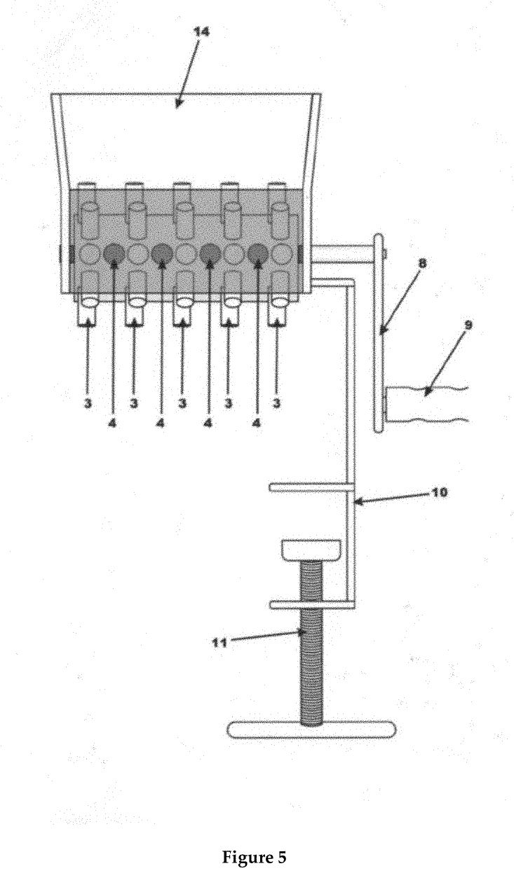

FIG. 5 shows the manual meat shredder 1 hopper 14 entry 19, showing the interspersed location of the rotating bars 3 and the fixed bars 4. The adjustable gap between the rotating bars 3 and the fixed bars 4 (selected through the width of the bars 3 and/or 4) provides the degree of shredding of the meat. Shown also is the handle 9, crank 8, chassis support 10 and press 11.

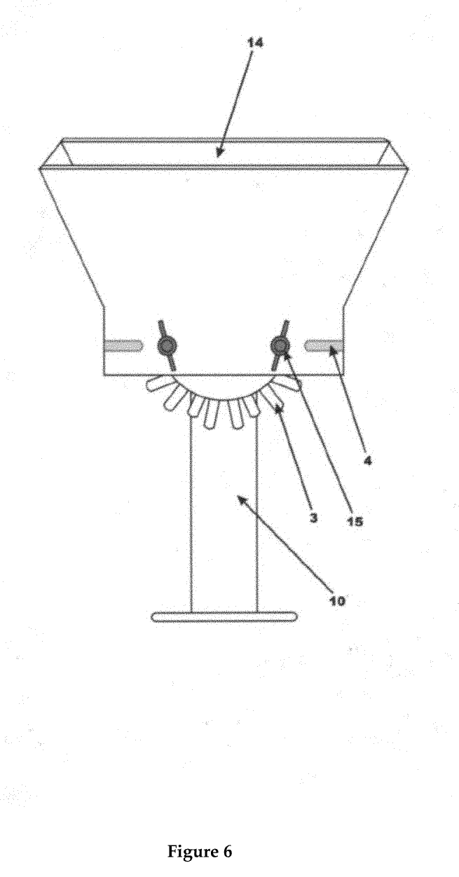

FIG. 6 shows the manual meat shredder 1 with the hopper 14 and its entry 19 being attached to the chassis 5 through the studs and wingnuts 15, protecting the shredding action performed by the rotating 3 and fixed 4 bars.

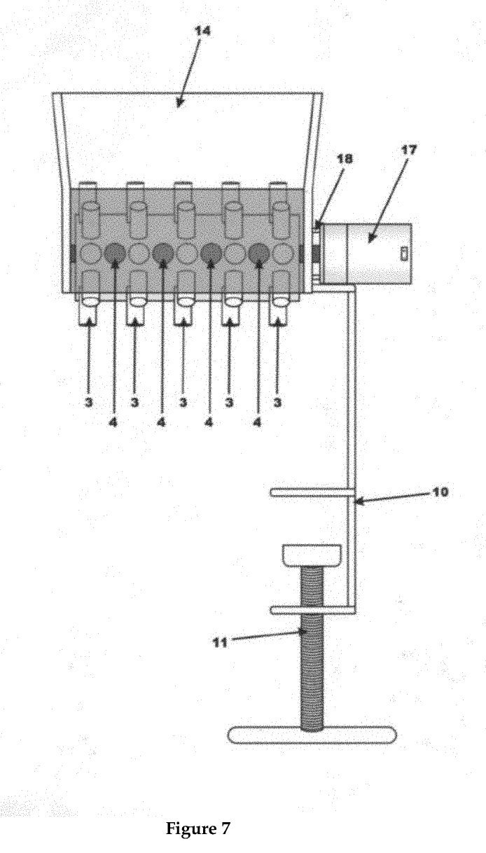

FIG. 7 shows the manual meat shredder 1 bars 3, 4 with the hopper 14 entry 19, support 10, clamp 11, with the bar carrier 2 rotation accomplished via a reduction gear motor 17 anchored by screws 18.

### MANUAL MEAT SHREDDER GLOSSARY

### 1. Manual Meat Shredder

### 2. Rotating Bar Carrier

3. Rotating bars
4. Fixed bars on Housing

### 5. Housing

### 6. Shaft

### 7. Slot

### 8. Rod/Lever

### 9. Handle

### 10. Support

### 11. Clamp

### 12. Tray

### 13. Meat

### 14. Shredded Meat

### 15. Wingnuts

### 16. Bolts/Studs

### 17. Reduced Gear Motor

### 18. Screws

### 19. Hopper Entry/Inlet

1. (canceled)

2. (canceled)

3. (canceled)

4. (canceled)

5. (canceled)

6. (canceled)

7. (canceled)

8. (canceled)

9.

10. (canceled)

11. An apparatus for shredding meat comprising;
a horizontal rotating central cylinder supported at both ends by a housing, with at least one shaft connected to at least at one end of said cylinder, said shaft protruding to said housing's exterior, wherein said housing has at least one each of a top and bottom opening;
said cylinder having one or more rows of rotating bars affixed along said cylinder's surface, and said housing having one or more rows of fixed bars affixed along one or more of said housing's side(s), with said fixed bars interspersed with said rotating bars so when they are located along the same plane a gap exists between said fixed bars and said rotating bars;
wherein said rotating bars and said fixed bars may have a circular, triangular, rectangular or any other regular geometric cross section; and
said at least one shaft has a mechanical component for rotation attached.

12. the apparatus of claim 11 further comprising;
a crank having a handle, said crank connected to said shaft.

13. the apparatus of claim 12 further comprising;
said housing having a hopper along the top side and a support member for attachment to a working surface.

14. the apparatus of claim 13 wherein;
said housing has one or more hopper holding mechanical components to hold said hopper, and said hopper has an opening that supports a tray; and
said housing support member has a surface securing component at one end.

15. the apparatus of claim 14 wherein;
said securing component is a clamp; and
said hopper holding mechanical components are comprised of nuts and butterfly nuts.

16. the apparatus of claim 12 wherein;
said rotating bars and said fixed bars are replaceable.

17. the apparatus of claim 16 further comprising;
said housing having a hopper along the top side and a support member for attachment to a working surface.

18. the apparatus of claim 17 wherein;
said housing has one or more hopper holding mechanical components to hold said hopper, and said hopper has an opening that supports a tray; and
said housing support member has a surface securing component at one end.

19. the apparatus of claim 18 wherein;
said securing component is a clamp; and
said hopper holding mechanical components are comprised of nuts and butterfly nuts.

20. the apparatus of claim 11 further comprising;
said shaft is connected to a motor.

21. the apparatus of claim 20 further comprising;
said housing having a hopper along the top side and a support member for attachment to a working surface.

22. the apparatus of claim 21 wherein;
said housing has one or more hopper holding mechanical components to hold said hopper, and said hopper has an opening that supports a tray; and
said housing support member has a surface securing component at one end.

23. the apparatus of claim 22 wherein;
said securing component is a clamp; and
said hopper holding mechanical components are comprised of nuts and butterfly nuts; and
said motor is a reduced gear motor.

24. the apparatus of claim 20 wherein;
said rotating bars and said fixed bars are replaceable.

25. the apparatus of claim 24 further comprising;
said housing having a hopper along the top side and a support member for attachment to a working surface.

26. the apparatus of claim 25 wherein;
said housing has one or more hopper holding mechanical components to hold said hopper, and said hopper has an opening that supports a tray; and
said housing support member has a surface securing component at one end.

27. the apparatus of claim 26 wherein;
said securing component is a clamp;
said hopper holding mechanical components are comprised of nuts and butterfly nuts; and
said motor is a reduced gear motor.
